(19) United States
(12) Patent Application Publication
(10) Pub. No.: US 2022/0198922 A1
(43) Pub. Date: Jun. 23, 2022

(54) SUPPORT DEVICE, METHOD, AND PROGRAM

(71) Applicant: TOYOTA JIDOSHA KABUSHIKI KAISHA, Aichi-ken (JP)

(72) Inventors: Masatoshi SATOH, Nagoya-shi (JP); Yosuke KIMURA, Nisshin-shi (JP); Kentaroh NAGAYA, Kasugai-shi (JP)

(21) Appl. No.: 17/549,875

(22) Filed: Dec. 14, 2021

(30) Foreign Application Priority Data
Dec. 18, 2020 (JP) 2020-210541

(51) Int. Cl. G08G 1/01; G08G 1/16

(52) U.S. Cl. CPC G08G 1/0129; G08G 1/0112; G08G 1/166; G08G 1/164; G08G 1/0145

(57) ABSTRACT

A data center server that acquires and accumulates traveling data from an in-vehicle system mounted on an individual vehicle functions as a specification unit and an extraction unit. The specification unit specifies a plurality of first vehicles that performs a predetermined driving operation at a first place among vehicles passing through the first place. The extraction unit extracts a driving operation common to the first vehicles in a period until the first vehicles reach the first place, from a traveling history of each of the first vehicles specified by the specification unit.

### CROSS-REFERENCE TO RELATED APPLICATION

This application claims priority to Japanese Patent Application No. 2020-210541 filed on Dec. 18, 2020, incorporated herein by reference in its entirety.

### BACKGROUND

### 1. Technical Field

The present disclosure relates to a support device, a support method, and a support program.

### 2. Description of Related Art

In Japanese Unexamined Patent Application Publication No. 2012-038006 (JP 2012-038006 A), when risk information is provided for a predetermined point on a road from the number of occurrences of a risk avoidance action, such as a sudden brake, and the number of occurrences of an accident, a degree of risk is set according to each factor of weather, day of a week, time zone, road surface condition, and traffic volume, in addition to the risk information.

### SUMMARY

When a predetermined driving operation, such as the sudden brake, is performed at a certain point on the road, in a case where the factor of the predetermined driving operation at the point can be estimated, it is possible to implement a safety measure at the point according to the estimated factor to reduce a frequency of performing the predetermined driving operation. However, in the technique described in JP 2012-038006 A, solely the degree of risk is evaluated based on the number of occurrences of the predetermined driving operation and the situation at that time (weather, day of the week, time zone, road surface condition, and traffic volume). Therefore, it is difficult to estimate the factor of the predetermined driving operation.

The present disclosure is to obtain a support device, a support method, and a support program capable of providing information for estimating a factor of a predetermined driving operation.

A first aspect of the present disclosure relates to a support device. The support device includes a specification unit configured to specify a plurality of first vehicles that performs a predetermined driving operation at a first place among vehicles passing through the first place, and an extraction unit configured to extract a driving operation common to the first vehicles in a period until the first vehicles reach the first place, from a traveling history of each of the first vehicles specified by the specification unit.

In the first aspect, the specification unit specifies the first vehicles that perform a predetermined driving operation at the first place among the vehicles passing through the first place. Each of the first vehicles performs the predetermined driving operation at the first place. Therefore, each traveling history of the first vehicles in the period until the first vehicles reach the first place may include a distinctive driving operation related to a factor of the predetermined driving operation.

In the first aspect, based on the above, the extraction unit extracts a driving operation common to the first vehicles in a period until the first vehicles reach the first place, from a traveling history of each of the first vehicles specified by the specification unit.

Accordingly, it is possible to provide information on the driving operation common to the first vehicles, that is, information capable of estimating the factor of the predetermined driving operation. With the estimation of the factor of the predetermined driving operation at the first place from the provided information, a safety measure is implemented on a road according to the estimated factor. Therefore, it is possible to reduce the frequency of the predetermined driving operation at the first place.

In a second aspect of the present disclosure, in the support device according to the first aspect, the specification unit may exclude a vehicle having the number or frequency of the predetermined driving operations that exceeds a threshold value from the first vehicles.

A vehicle driven by a driver who frequently performs the predetermined driving operation on a routine basis (for example, a rough driver) may be mixed among the first vehicles that perform the predetermined driving operation at the first place. When such a vehicle is mixed in the first vehicles, the information accuracy of the driving operation common to the first vehicles is lowered (relationship between the driving operation common to the extracted first vehicles and the factor of the predetermined driving operation is lowered). On the contrary, in the second aspect, the vehicle having the number or frequency of the predetermined driving operations that exceeds the threshold value is excluded from the first vehicles. Therefore, it is possible to improve the information accuracy of the driving operation common to the first vehicles and to improve the estimation accuracy of the factor of the predetermined driving operation.

In a third aspect of the present disclosure, in the support device according to the first aspect or the second aspect, the predetermined driving operation may include any of sudden brake, sudden steering, sudden acceleration, or horn.

According to the third aspect, it is possible to provide information capable of estimating a factor of any of the sudden brake, the sudden steering, the sudden acceleration, or the horn, at a place where any of the sudden brake, the sudden steering, the sudden acceleration, or the horn is performed.

In a fourth aspect of the present disclosure, in the support device according to any one of the first to third aspects, the specification unit may also specify a plurality of second vehicles passing by any of the first vehicles at the first place from traveling history information of the vehicles passing through the first place, and the extraction unit may also extract a driving operation common to the second vehicles in a period until the second vehicles reach the first place, from traveling history information of each of the second vehicles specified by the specification unit.

In the fourth aspect, the second vehicles are vehicles passing by any of the first vehicles at the first place. Therefore, a traveling history of each of the second vehicles in the period until the second vehicles reach the first place may also include a distinctive driving operation related to a factor of the predetermined driving operation in the first vehicle. An example of the distinctive driving operation includes a case where the first vehicle passed by is suddenly braked due to going out of a traffic lane by the second vehicle at the first place.

In consideration of the above, in the fourth aspect, the second vehicles passing by any of the first vehicles at the first place are also specified from the traveling history information of the vehicles passing through the first place, and the driving operation common to the second vehicles in the period until the second vehicles reach the first place is also extracted from the traveling history information of each of the specified second vehicles. Accordingly, it is possible to provide information on the driving operation common to the second vehicles, that is, information capable of estimating the factor of the predetermined driving operation in the first vehicle.

In a fifth aspect of the present disclosure, the support device according to any one of the first to fourth aspects may further include an output unit configured to output a candidate for a safety measure at the first place based on a factor of the predetermined driving operation at the first place, which is estimated from the common driving operation.

In the fifth aspect, the candidate for the safety measure in the first place is output based on the factor of the predetermined driving operation in the first place. Therefore, it is possible to save the trouble of listing candidates for the safety measure and to save the work of examining the safety measure to be implemented in the first place, in examining the safety measure to be implemented in the first place.

In a sixth aspect of the present disclosure, the support device according to any one of the first to fifth aspects may further include a comparison unit configured to specify a third vehicle smoothly passing through a second place where a predetermined safety measure is implemented before the predetermined safety measure is implemented and a fourth vehicle smoothly passing through the second place after the predetermined safety measure is implemented and compare a traveling history of the third vehicle with a traveling history of the fourth vehicle.

According to the sixth aspect, it is possible to save the work of evaluating the effect of the predetermined safety measure implemented to the second place. The vehicles smoothly passing through the second place are specified as the third vehicle and the fourth vehicle. Therefore, for example, with exclusion of a vehicle that cannot smoothly pass through the second place to be processed due to the influence of surrounding conditions, such as a traffic jam, it is possible to evaluate the effect of the predetermined safety measure more accurately.

A seventh aspect of the present disclosure relates to a support method executed by a computer. The support method includes specifying a plurality of first vehicles that performs a predetermined driving operation at a first place among vehicles passing through the first place, and extracting a driving operation common to the first vehicles in a period until the first vehicles reach the first place, from a traveling history of each of the specified first vehicles.

According to the seventh aspect, it is possible to provide the information capable of estimating the factor of the predetermined driving operation, similarly to the first aspect.

An eighth aspect of the present disclosure relates to a support program causing a computer to execute a process including specifying a plurality of first vehicles that performs a predetermined driving operation at a first place among vehicles passing through the first place, and extracting a driving operation common to the first vehicles in a period until the first vehicles reach the first place, from a traveling history of each of the specified first vehicles.

According to the eighth aspect, it is possible to provide information capable of estimating the factor of the predetermined driving operation, similarly to the first aspect.

The present disclosure has an effect that it is possible to provide the information capable of estimating the factor of the predetermined driving operation.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a block diagram showing a schematic configuration of a safety measure support system according to an embodiment;

FIG. 2 is a functional block diagram of a server;

FIG. 3 is a flowchart showing a safety measure support process;

FIG. 4 is a flowchart showing a support process 1;

FIG. 5 is an explanatory diagram for describing a process of extracting a vehicle having an extremely large number of sudden brakes by clustering;

FIG. 6 is an image diagram showing an output example of distribution of sudden brake occurrence places;

FIG. 7 is a flowchart showing a support process 2;

FIG. 8 is an image diagram showing a result of comparing traveling data of a first vehicle that is suddenly braked at an intersection with traveling data of another vehicle that is not suddenly braked;

FIG. 9 is an image diagram showing an output example of a risk value for each sudden brake occurrence place;

FIG. 10 is an image diagram showing an output example of a driving operation common to the first vehicle that is suddenly braked;

FIG. 11 is an image diagram showing an output example of a driving operation common to a second vehicle passing by the first vehicle that is suddenly braked;

FIG. 12 is a flowchart showing a support process 3;

FIG. 13 is a table showing an example of safety measure information;

FIG. 14 is a flowchart showing a support process 4;

FIG. 15 is an image diagram for describing a process of excluding data of a vehicle decelerated by a predetermined value or more in the support process 4; and

FIG. 16 is an image diagram for describing an example of a process of comparing data before a safety measure and data after the safety measure in the support process 4.

### DETAILED DESCRIPTION OF EMBODIMENTS

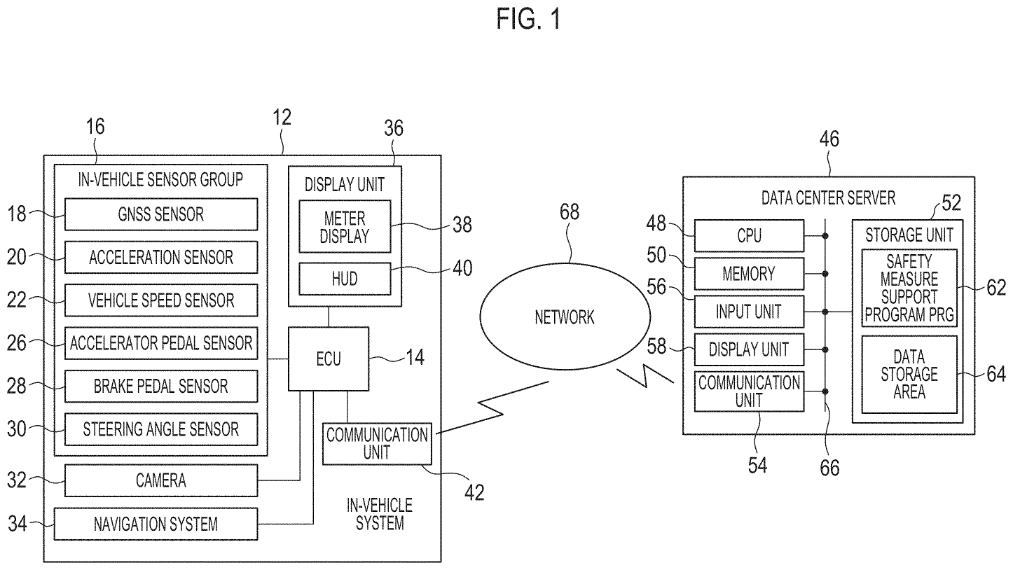

Hereinafter, an example of an embodiment of the present disclosure will be described in detail with reference to drawings. As shown in FIG. 1, a safety measure support system 10 according to the embodiment includes an in-vehicle system 12 mounted on a vehicle and a data center server 46 (hereinafter, simply referred to as a server 46). The in-vehicle system 12 and the server 46 can communicate with each other through a network 68. Although solely one in-vehicle system 12 is shown in FIG. 1, the in-vehicle system 12 is mounted on each of a plurality of vehicles.

The in-vehicle system 12 includes an electronic control unit (ECU) 14. A communication unit 42 configured to control communication with an in-vehicle sensor group 16, a camera 32, a navigation system 34, a display unit 36 configured to display predetermined information, the server 46, and the like is connected to the ECU 14.

The in-vehicle sensor group 16 includes a GNSS sensor 18 that receives a positioning signal from a global navigation satellite system (GNSS) satellite to acquire GNSS positioning information, an acceleration sensor 20 that measures acceleration of the vehicle, and a vehicle speed sensor 22 that measures a speed of the vehicle. The in-vehicle sensor group 16 includes an accelerator pedal sensor 26 that measures a depression amount of an accelerator pedal, a brake pedal sensor 28 that measures a depression amount of a brake pedal, and a steering angle sensor 30 that measures a steering angle of the vehicle.

Each sensor of the in-vehicle sensor group 16 measures various physical quantities for each predetermined time while an ignition switch of the vehicle is turned on. The sensor data (also referred to as controller area network (CAN) data) measured by each sensor of the in-vehicle sensor group 16 is transmitted to the server 46 at any time or every time a predetermined amount of data is accumulated.

The camera 32 images the front of the vehicle while the ignition switch of the vehicle is turned on. Image data captured by the camera 32 is also transmitted to the server 46 at any time or every time a predetermined amount of image data is accumulated.

The navigation system 34 includes a storage unit (not shown) configured to store map information, and performs a process of displaying a position of the own vehicle on a map displayed on the display unit 36 or guiding a path to a destination based on the GNSS positioning information output from the GNSS sensor 18 and the map information stored in the storage unit.

The display unit 36 includes a meter display 38 and a head-up display (HUD) 40. The HUD 40 according to the present embodiment is a small HUD, which forms an image in a lower part of the foreground, in which a part of a front field of view of an occupant of the own vehicle is set as a display range by reflection on a windshield glass or the like. The meter display 38 is a display provided on an instrument panel of the own vehicle.

The server 46 includes a central processing unit (CPU) 48, a memory 50 including a read only memory (ROM) and a random access memory (RAM), and a non-volatile storage unit 52, such as a hard disk drive (HDD) or a solid state drive (SSD). The server 46 also includes a communication unit 54 configured to control communication with the in-vehicle system 12 and the like, an input unit 56, such as a keyboard, and a display unit 58, such as a display. The CPU 48, the memory 50, the storage unit 52, the communication unit 54, the input unit 56, and the display unit 58 are connected so as to be able to communicate with each other through an internal bus 66.

The storage unit 52 stores a safety measure support program 62 and is provided with a data storage area 64. The data storage area 64 accumulates and stores time-series traveling data (sensor data of the in-vehicle sensor group 16 and captured image data of the camera 32) related to traveling of the vehicle, which is acquired from each vehicle, including data related to a driving history of the vehicle.

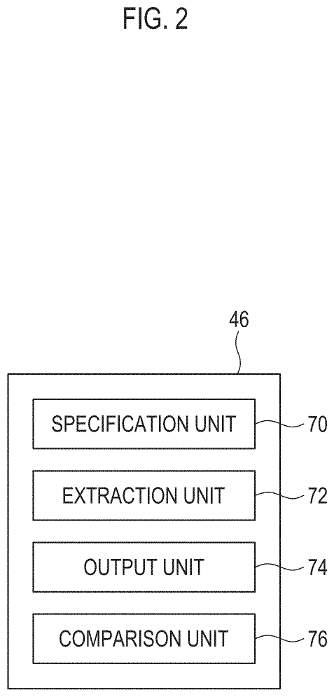

The safety measure support program 62 is read out from the storage unit 52 and developed in the memory 50, and the safety measure support program 62 developed in the memory 50 is executed by the CPU 48 to cause the server 46 to function as a specification unit 70, an extraction unit 72, an output unit 74, and a comparison unit 76 shown in FIG. 2 and to perform a safety measure support process described below. The server 46 is an example of a support device.

The specification unit 70 specifies a plurality of first vehicles that performs a predetermined driving operation at a first place among vehicles passing through the first place. An example of the predetermined driving operation is a sudden brake. The specification unit 70 excludes a vehicle having the number or frequency of the predetermined driving operations that exceeds a threshold value from the first vehicles. The specification unit 70 also specifies a plurality of second vehicles passing by any of the first vehicles at the first place from traveling history information of the vehicles passing through the first place.

The extraction unit 72 extracts the driving operation common to the first vehicles in a period until the first vehicles reach the first place, from a traveling history information of each of the first vehicles specified by the specification unit 70. The extraction unit 72 also extracts the driving operation common to the second vehicles in the period until the second vehicles reach the first place, from traveling history information of each of the second vehicles specified by the specification unit 70.

The output unit 74 outputs a candidate for the safety measure in the first place based on the factor of the predetermined driving operation in the first place, which is estimated from the common driving operation. The comparison unit 76 specifies a third vehicle smoothly passing through a second place, where a predetermined safety measure is implemented, before the predetermined safety measure is implemented and specifies a fourth vehicle smoothly passing through the second place after the predetermined safety measure is implemented and compare a traveling history of the third vehicle with a traveling history of the fourth vehicle.

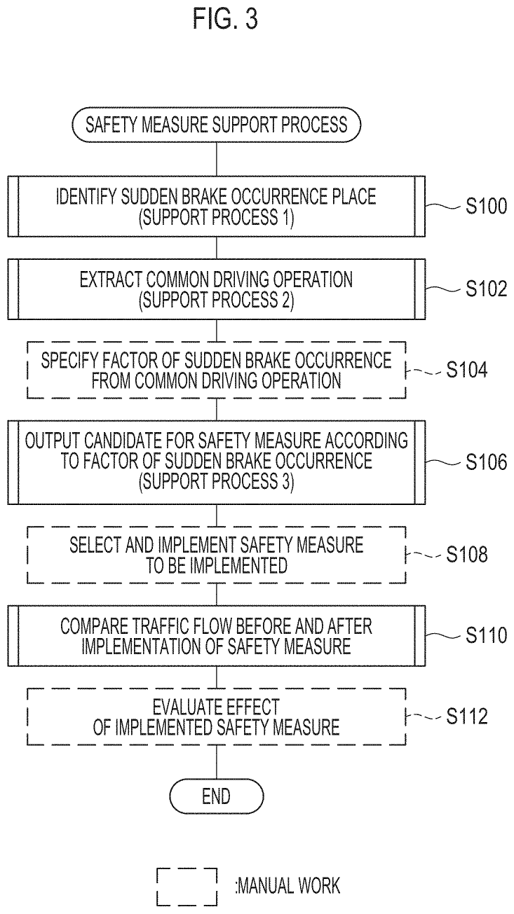

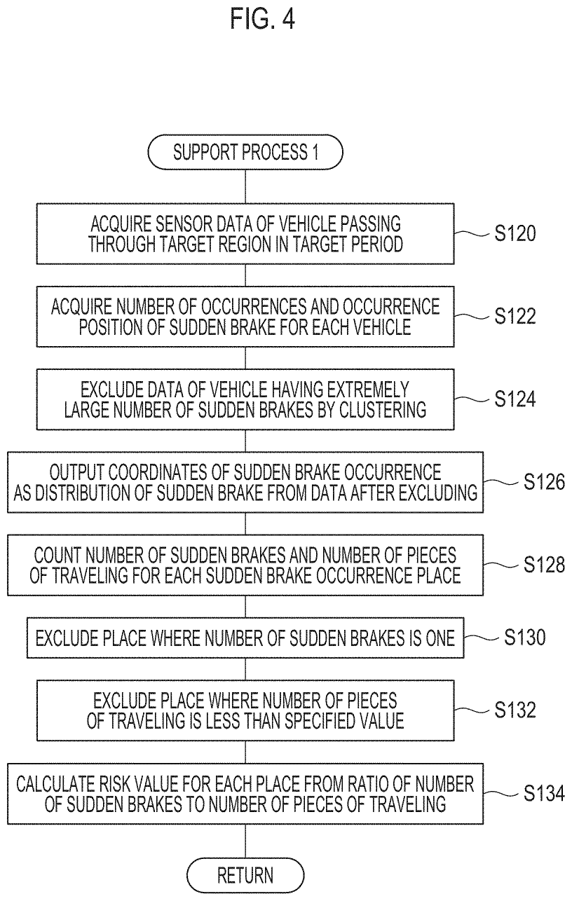

Next, as an action of the present embodiment, first, the safety measure support process according to the present embodiment will be described with reference to FIG. 3. In step S100 of the safety measure support process, the server 46 performs a support process 1 for identifying a sudden brake occurrence place. Details of the support process 1 will be described with reference to FIG. 4.

In step S120 of the support process 1, the server 46 acquires traveling data of all vehicles passing through a region to be processed set in advance from the data storage area 64, in a period to be processed set in advance (6 months as an example). In step S122, the server 46 acquires the number of occurrences of the sudden brake and an occurrence position in the region to be processed for each vehicle based on the traveling data acquired in step S120. An example of the sudden brake can be a case of decelerating with deceleration of −0.4 G or more.

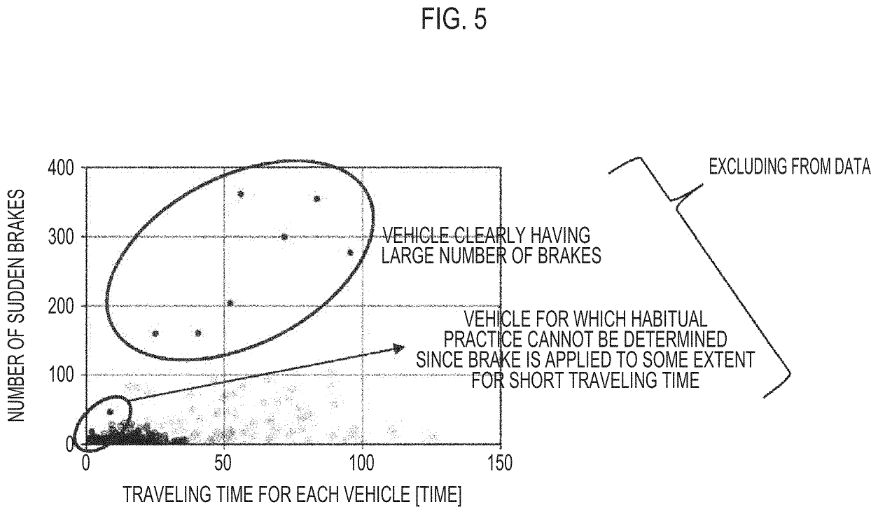

In step S124, the server 46 extracts a vehicle having an extremely large number of sudden brakes by clustering based on the traveling data acquired in step S120. Specifically, for example, a scatter diagram is created in which a cumulative traveling time for each vehicle is implemented on the horizontal axis and the number of sudden brakes for each vehicle is implemented on the vertical axis, as shown in FIG. 5, to perform the clustering by a k-means method or the like with “traveling time”, “number of brakes”, and “number of brakes per hour” as explanatory variables. With this clustering, it is possible to separate and extract, from a whole, a group of vehicles clearly having a large number of sudden brakes and a group of vehicles that are suddenly braked for a short traveling time. In step S124, the extracted traveling data of the vehicle having an extremely large number of sudden brakes is excluded from the traveling data acquired in step S120. Accordingly, it is possible to suppress that the traveling data of the vehicle for which a driver is estimated to drive roughly adversely affects subsequent processes.

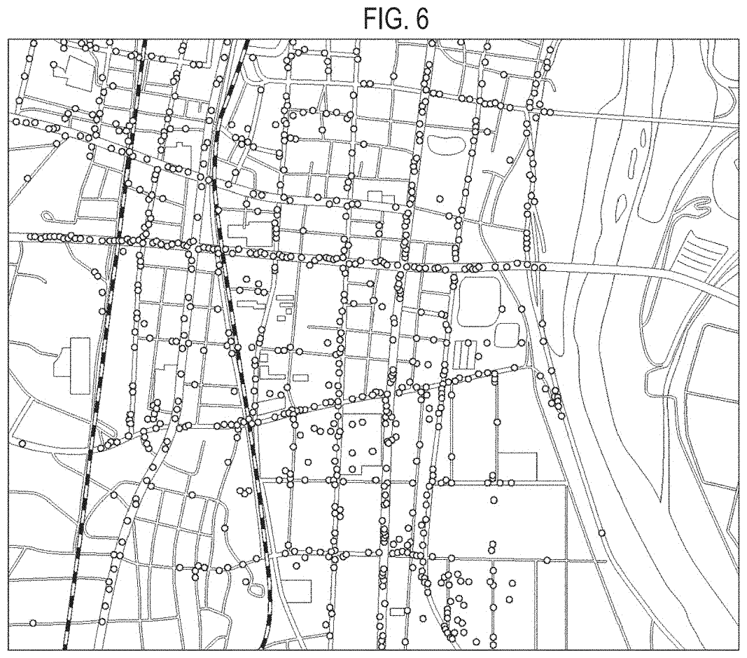

In step S126, the server 46 outputs coordinates of the sudden brake occurrence place in the region to be processed as distribution of the sudden brake based on the traveling data after excluding the traveling data of the vehicle having an extremely large number of sudden brakes. As an example, FIG. 6 shows an output example of the distribution of the sudden brake occurrence places. In FIG. 6, the sudden brake occurrence place is indicated by a dot.

In step S128, the server 46 counts the number of sudden brakes and the number of pieces of traveling for each sudden brake occurrence place. In step S130, the server 46 excludes a place where the number of sudden brakes is one from the sudden brake occurrence places. Accordingly, a place where a sudden brake occurs accidentally, such as a sudden brake occurrence place due to an animal jumping out, is excluded from the sudden brake occurrence places.

In step S132, the server 46 excludes a place where the number of pieces of traveling is less than a specified value from the sudden brake occurrence places. Accordingly, a place with low priority in implementing the safety measure due to a low traffic volume of vehicles is excluded from the sudden brake occurrence places.

In step S134, the server 46 calculates a risk value for each of individual sudden brake occurrence places from a ratio of the number of sudden brakes to the number of pieces of traveling.

Risk value=number of sudden brakes/number of pieces of traveling When the sudden brake occurrence place is identified as described above, the support process 1 ends and the process proceeds to step S102 of the safety measure support process.

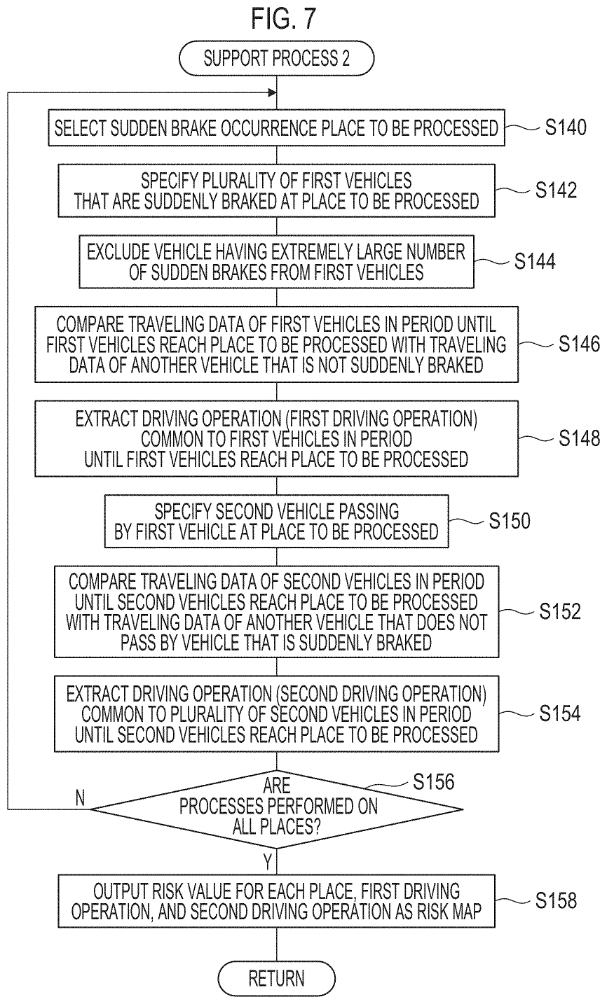

In step S102 of the safety measure support process, the server 46 performs a support process 2 of extracting the common driving operation for the first vehicle that is suddenly braked and the second vehicle passing by the first vehicle. Details of the support process 2 will be described with reference to FIG. 7.

In step S140, the server 46 selects a sudden brake occurrence place to be processed from among the sudden brake occurrence places identified in the support process 1. The sudden brake occurrence place to be processed is an example of the first place and will be hereinafter referred to as the “first place”. In step S142, the specification unit 70 specifies the first vehicles that are suddenly braked at the first place based on the traveling data accumulated and stored in the data storage area 64. In step S144, the specification unit 70 performs the same clustering as in step S124 described above to exclude the vehicle having an extremely large number of sudden brakes from the first vehicles extracted in step S142.

In step S146, the extraction unit 72 compares traveling data (for example, front-rear direction acceleration and vehicle speed) of the first vehicles in the period until the first vehicles reach the first place with traveling data of another vehicle that is not suddenly braked at the first place. In step S148, the extraction unit 72 extracts the driving operation (first driving operation) common to the first vehicles in a period until the first vehicles reach a place to be processed based on the comparison result of the traveling data in step S146.

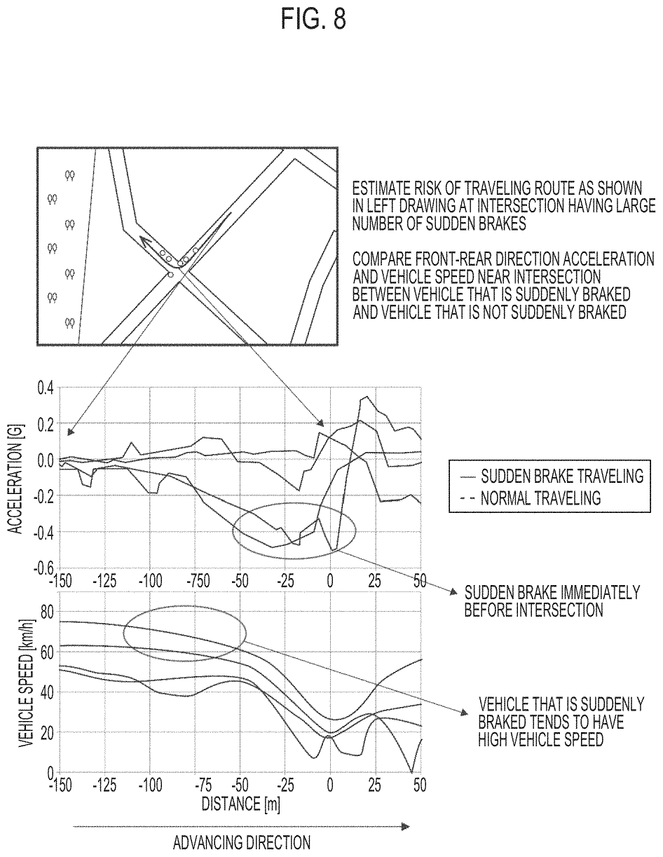

As an example, FIG. 8 shows a result of comparing the traveling data of the first vehicle that is suddenly braked immediately before an intersection with the traveling data of another vehicle passing through the intersection without being suddenly braked, among vehicles travels on a traveling route that enters the intersection, having a large number of sudden brakes, from a northeast direction and turns right at the intersection. In the traveling data of the first vehicle shown in FIG. 8, a common driving operation of entering the intersection at an excessive speed appears as a distinctive driving operation related to the factor of the sudden brake. In the place where such an event occurs frequently, “intersection entry at excessive speed” is extracted as the first driving operation common to the first vehicles.

The first driving operation common to the first vehicles is not limited to a driving operation performed by all the first vehicles and also includes a driving operation performed by the first vehicles of a predetermined ratio (for example, 80%) or more.

In step S150, the extraction unit 72 compares the traveling data of the first vehicle that is suddenly braked at the first place with the traveling data accumulated and stored in the data storage area 64 to specify the first vehicle that is suddenly braked at the first place and the second vehicles passing by the first vehicle at the first place.

In step S152, the extraction unit 72 compares the traveling data of the second vehicle in the period until the second vehicle reach the first place with the traveling data of another vehicle that does not pass by the vehicle that is suddenly braked at the first place. In step S154, the extraction unit 72 extracts the driving operation (second driving operation) common to the second vehicles in the period until the second vehicles reach the place to be processed based on the comparison result of the traveling data in step S152.

The factor of the sudden brake of the first vehicle may be the driving operation itself of the first vehicle such as the intersection entry of the first vehicle at excessive speed and may be a driving operation of another vehicle other than the first vehicle. An example of the driving operation of another vehicle includes a case where an oncoming first vehicle is suddenly braked due to traveling of the second vehicle with a large bulge when the second vehicle turns left at an intersection and passes by the first vehicle. In a place where such an event occurs frequently, “large bulge when turning left” is extracted as the second driving operation common to the second vehicles.

The second driving operation common to the second vehicles is not limited to a driving operation performed by all the second vehicles and also includes a driving operation performed by the second vehicles of a predetermined ratio (for example, 80%) or more.

In next step S156, the server 46 determines whether or not the processes after step S140 are performed on all the sudden brake occurrence places identified in the support process 1. When the determination in step S156 is negative, the process returns to step S140, and steps 140 to 156 are repeated until the determination in step S156 is affirmative. When the processes after step S140 are performed on all the sudden brake occurrence places identified in the support process 1, the determination in step S156 is affirmative and the process proceeds to step S158.

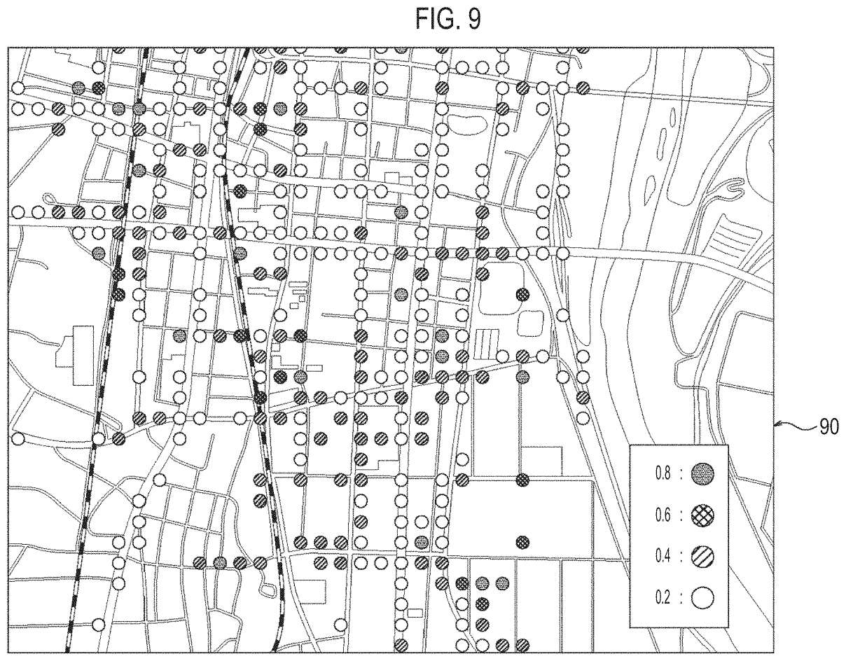

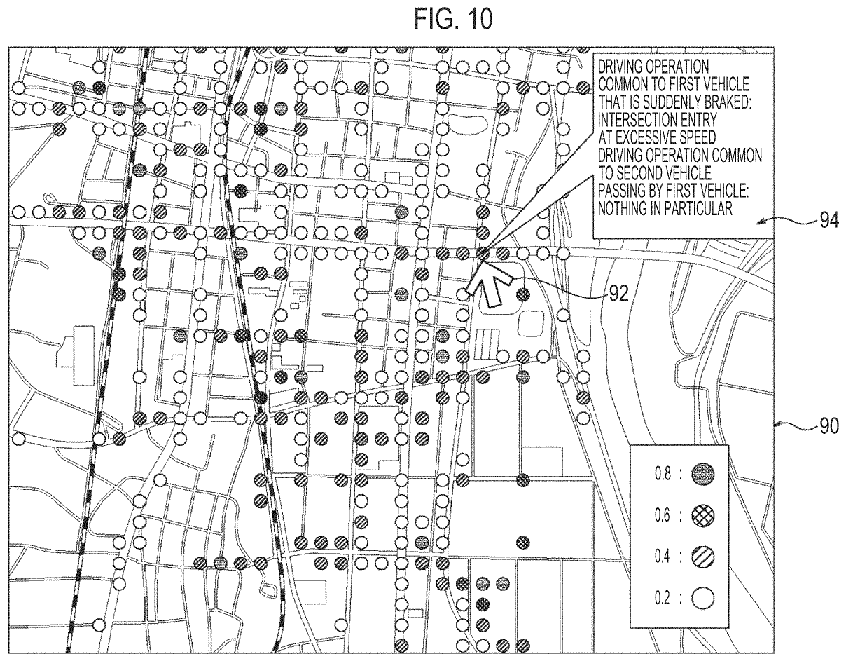

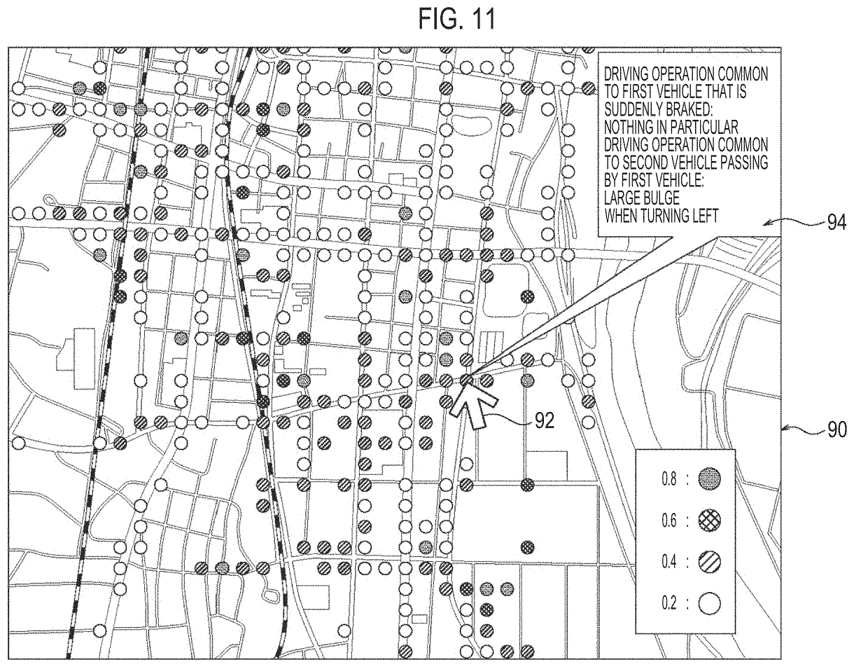

In step S158, the server 46 outputs the risk value for each of the individual sudden brake occurrence places, the first driving operation, and the second driving operation to the display unit 58 as a risk map 90 as shown in FIG. 9 as an example, and ends the support process 2. The individual sudden brake occurrence place is indicated as a dot on the risk map 90, and a type of the dot (for example, display color) is different according to the risk value at the individual sudden brake occurrence place. As shown in FIGS. 10 and 11, in the first driving operation and the second driving operation, when a cursor 92 is placed on any one of dots, corresponding information 94 is popped up and displayed.

Output forms of the risk value for each sudden brake occurrence place, the first driving operation, and the second driving operation are not limited to the forms shown in FIGS. 9 to 11. For example, a map showing a risk value for each mesh when the region to be processed is divided into a plurality of meshes of unit area (for example, a mesh of 50 m square) may be output instead of the risk map showing the risk value for each sudden brake occurrence place.

When the support process 2 ends, the process proceeds to step S104 of the safety measure support process shown in FIG. 3. In step S104, an operator refers to the output risk map 90 to select a sudden brake occurrence place where the safety measure is requested from among the sudden brake occurrence places indicated as the dots in the risk map 90. The operator places the cursor 92 on a dot corresponding to the selected sudden brake occurrence place where the safety measure is requested to specify a factor of the sudden brake occurrence at the sudden brake occurrence place where the safety measure is requested, from the pop-up display of the first driving operation and the second driving operation.

For example, when the information shown in FIG. 10 is popped up and displayed, the operator specifies that the factor of the sudden brake occurrence is due to the intersection entry of the first vehicle that is suddenly braked at excessive speed. When the information shown in FIG. 11 is popped up and displayed, the operator specifies that the factor of the sudden brake occurrence is due to the large bulge of the second vehicle, passing by the first vehicle that is suddenly braked, when turning left.

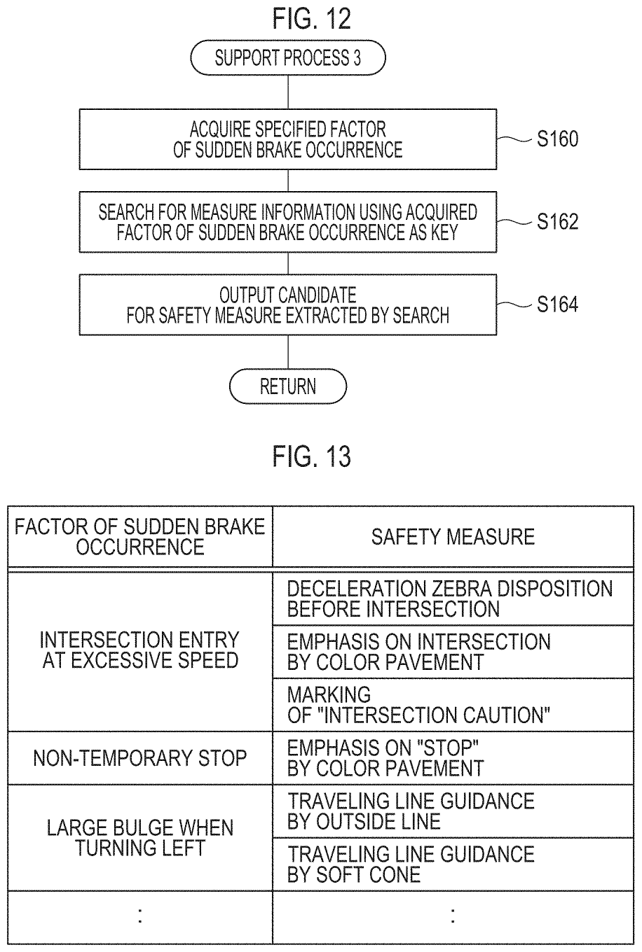

When the operator specifies the factor of the sudden brake occurrence, in next step S106, the server 46 performs a support process 3 of outputting the candidate for the safety measure according to the factor of the sudden brake occurrence. Details of the support process 3 will be described with reference to FIG. 12.

In step S160, the output unit 74 acquires the factor of the sudden brake occurrence at the sudden brake occurrence place where the safety measure is requested, which is specified by the operator. In the present embodiment, safety measure information registered in association with a possible candidate for the safety measure for each factor of the sudden brake occurrence is stored in advance in the storage unit 52, as shown in FIG. 13 as an example. In next step S162, the output unit 74 searches for the safety measure information using the factor of the sudden brake occurrence acquired in step S160 as a key.

In step S164, the output unit 74 outputs the candidate for the safety measure extracted by the search in step S162 to the display unit 58. For example, when the factor of the sudden brake occurrence is “intersection entry at excessive speed”, “deceleration zebra disposition before intersection”, “emphasis on intersection by color pavement”, and “marking of” “intersection caution” are respectively output as the candidates for the safety measure. Further, for example, when the factor of the sudden brake occurrence is “large bulge when turning left”, “traveling line guidance by outside line” and “traveling line guidance by soft cone” are respectively output as the candidates for the safety measure.

When the above support process 3 ends, the process proceeds to step S108 of the safety measure support process shown in FIG. 3. In step S108, the operator refers to the output candidates for the safety measure to select a safety measure to be implemented at the sudden brake occurrence place where the safety measure is requested, from among the output candidates for the safety measure. The operator arranges for the selected safety measure to be implemented at the sudden brake occurrence place where the safety measure is requested. The sudden brake occurrence place where the safety measure is implemented is an example of the second place and will be hereinafter referred to as the “second place”.

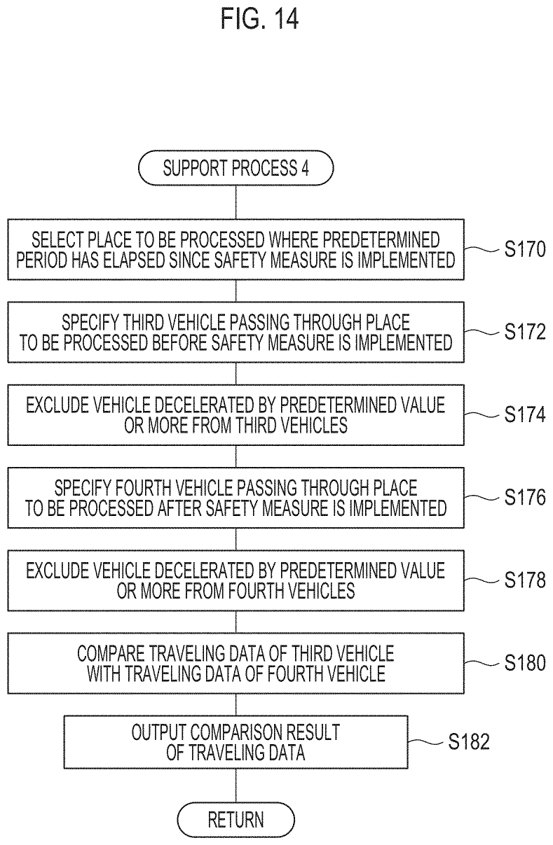

At a timing when a predetermined period (for example, several months) or more has elapsed since the safety measure is implemented at the second place, in step S110 of the safety measure support process shown in FIG. 3, the server 46 performs a support process 4 of comparing a traffic flow before and after the implementation of the safety measure. Details of the support process 4 will be described with reference to FIG. 14.

In step S170, the comparison unit 76 selects a second place to be processed where the predetermined period or more has elapsed since the safety measure is implemented. In step S172, the comparison unit 76 specifies the third vehicle passing through the second place to be processed before the safety measure is implemented, based on the traveling data accumulated and stored in the data storage area 64, to acquire the traveling data when the specified third vehicle passes through the second place to be processed.

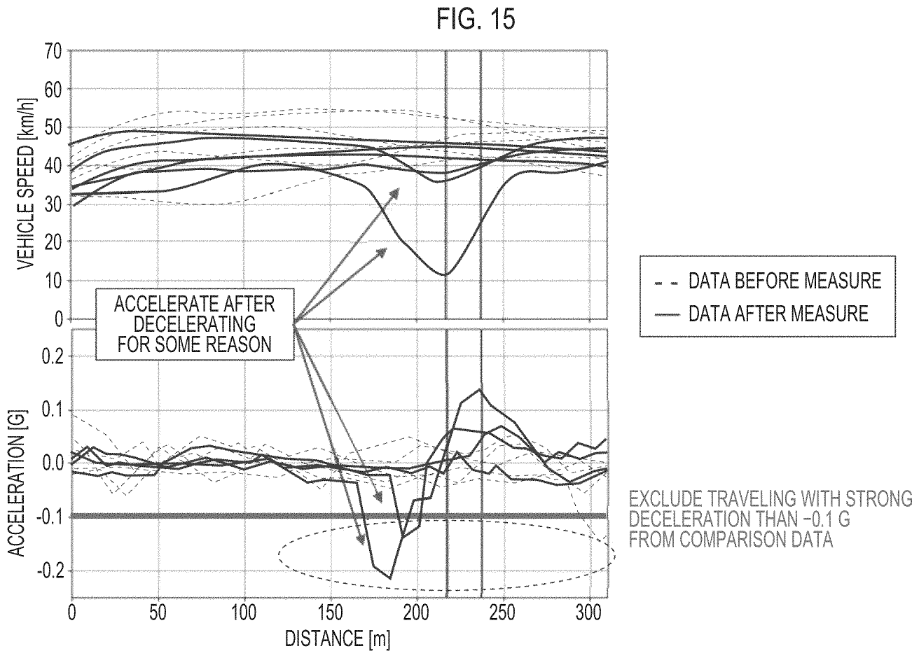

In step S174, the comparison unit 76 excludes, from the third vehicles, a vehicle decelerated by a predetermined value or more (for example, −0.1 G or more) when passing through the second place to be processed among the third vehicles specified in step S172 (refer to also FIG. 15). Accordingly, a vehicle that cannot smoothly pass through the second place to be processed due to the influence of surrounding conditions, such as a traffic jam and a bicycle, is excluded from the third vehicles.

In step S176, the comparison unit 76 specifies the fourth vehicle passing through the second place to be processed after the safety measure is implemented, based on the traveling data accumulated and stored in the data storage area 64, to acquire the traveling data when the specified fourth vehicle passes through the second place to be processed.

In step S178, the comparison unit 76 excludes, from the fourth vehicles, a vehicle decelerated by a predetermined value or more (for example, −0.1 G or more) among the fourth vehicles specified in step S176 (refer to also FIG. 15). Accordingly, a vehicle that cannot smoothly pass through the second place to be processed due to the influence of surrounding conditions, such as a traffic jam and a bicycle, is excluded from the fourth vehicles.

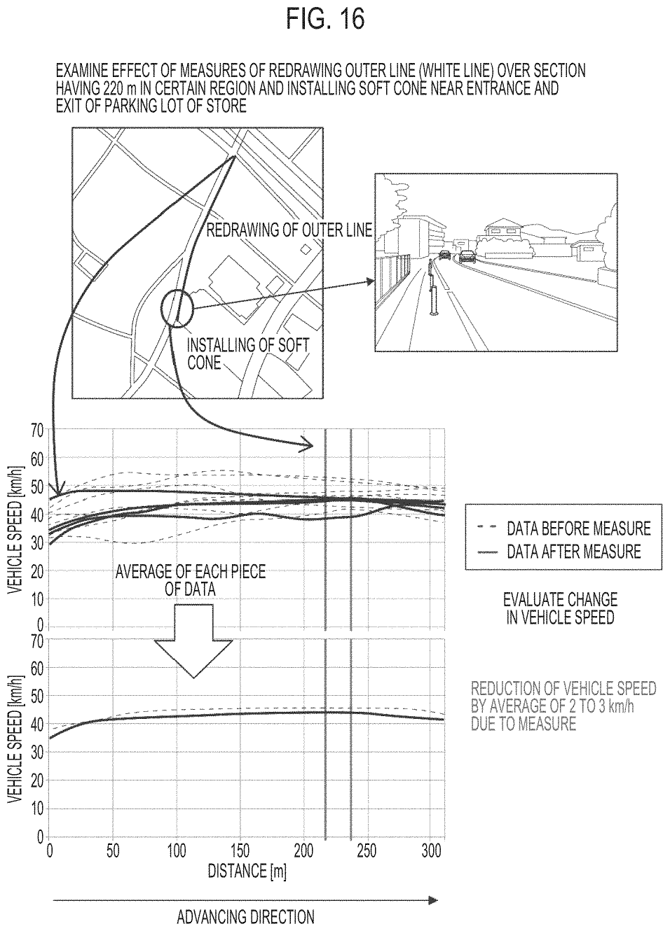

In step S180, the comparison unit 76 compares, for example, average vehicle speeds of the traveling data of the third vehicle and the traveling data of the fourth vehicle. As an example, FIG. 16 shows an example of comparing the traveling data of the third vehicle passing through the second place before the measure with the traveling data of the fourth vehicle passing through the second place after the measure, for the second place where safety measures of redrawing an outside line (white line) over a section having a total length of 220 m and installing a soft cone near the entrance and exit of a parking lot of a store are implemented. In the example shown in FIG. 16, a vehicle speed of the fourth vehicle is reduced by an average of 2 km/h to 3 km/h as compared with a vehicle speed of the third vehicle.

In step S182, the comparison unit 76 outputs the result of comparing the traveling data of the third vehicle and the traveling data of the fourth vehicle to the display unit 58, and the support process 4 ends. When the support process 4 ends, the process proceeds to step S112 of the safety measure support process shown in FIG. 3.

In step S112, the operator evaluates the effect of the safety measure implemented to the second place to be processed based on the comparison result of the traveling data of the third vehicle and the fourth vehicle output by the support process 4. For example, in the example shown in FIG. 16, the average vehicle speed decreases with the redrawing of the outer line and the installation of the soft cone. Therefore, the operator evaluates that the safety measure is effective.

As described above, in the present embodiment, the specification unit 70 specifies the first vehicles that perform the predetermined driving operation at the first place among the vehicles passing through the first place. The extraction unit 72 extracts the driving operation common to the first vehicles in the period until the first vehicles reach the first place, from the traveling history of each of the first vehicles specified by the specification unit 70. Accordingly, it is possible to provide information on the driving operation common to the first vehicles, that is, information capable of estimating the factor of the predetermined driving operation.

In the present embodiment, the specification unit 70 excludes the vehicle having the number or frequency of the predetermined driving operations that exceeds the threshold value from the first vehicles. Accordingly, it is possible to improve the estimation accuracy of the factor of the predetermined driving operation.

In the present embodiment, the predetermined driving operation includes the sudden brake. Accordingly, it is possible to provide the information capable of estimating the factor of the sudden brake at the place where the sudden brake is applied.

In the present embodiment, the specification unit 70 also specifies the second vehicles passing by any of the first vehicles at the first place from the traveling history information of the vehicles passing through the first place. The extraction unit 72 also extracts the driving operation common to the second vehicles in the period until the second vehicles reach the first place, from the traveling history information of each of the second vehicles specified by the specification unit 70. Accordingly, it is possible to provide information on the driving operation common to the second vehicles, that is, information capable of estimating the factor of the predetermined driving operation in the first vehicle.

In the present embodiment, the output unit 74 outputs the candidate for the safety measure at the first place based on the factor of the predetermined driving operation at the first place, which is estimated from the common driving operation. Accordingly, in examining the safety measure to be implemented in the first place, it is possible to save the trouble of listing the candidates for the safety measure and to save the work of examining the safety measure to be implemented in the first place.

In the present embodiment, the comparison unit 76 specifies the third vehicle smoothly passing through the second place, where the predetermined safety measure is implemented, before the predetermined safety measure is implemented and the fourth vehicle smoothly passing through the second place after the predetermined safety measure is implemented and compare the traveling history of the third vehicle with the traveling history of the fourth vehicle. Accordingly, it is possible to save the work of evaluating the effect of the predetermined safety measure implemented to the second place and to evaluate the effect of the predetermined safety measure more accurately.

In the above description, the aspect in which the sudden brake is employed as the predetermined driving operation has been described, but the present disclosure is not limited thereto. Other driving operations such as sudden steering, sudden acceleration, and a horn may be employed as the predetermined driving operation.

In the above description, in the support process 4, the aspect in which the third vehicle and the fourth vehicle are specified separately has been described, but the present disclosure is not limited thereto. For example, a list of vehicles (list 3) included in each of a specified third vehicle list (list 1) and a specified fourth vehicle list (list 2) may be created, and traveling data of the vehicle included in the list 3 before the safety measure may be compared with traveling data of the vehicle included in the list 3 after the safety measure.

In the above description, the aspect in which the safety measure support program 62, which is an example of the support program according to the present disclosure, is stored (installed) in the storage unit 52 in advance has been described. The support program according to the present disclosure may be provided in a form of being recorded on a non-transitory recording medium, such as an HDD, an SSD, or a DVD.

What is claimed is:

1. A support device comprising:
a specification unit configured to specify a plurality of first vehicles that performs a predetermined driving operation at a first place among vehicles passing through the first place; and
an extraction unit configured to extract a driving operation common to the first vehicles in a period until the first vehicles reach the first place, from a traveling history of each of the first vehicles specified by the specification unit.

2. The support device according to claim 1, wherein the specification unit excludes a vehicle having the number or frequency of the predetermined driving operations that exceeds a threshold value from the first vehicles.

3. The support device according to claim 1, wherein the predetermined driving operation includes any of sudden brake, sudden steering, sudden acceleration, or horn.

4. The support device according to claim 1, wherein:
the specification unit also specifies a plurality of second vehicles passing by any of the first vehicles at the first place from traveling history information of the vehicles passing through the first place; and
the extraction unit also extracts a driving operation common to the second vehicles in a period until the second vehicles reach the first place, from traveling history information of each of the second vehicles specified by the specification unit.

5. The support device according to claim 1, further comprising an output unit configured to output a candidate for a safety measure at the first place based on a factor of the predetermined driving operation at the first place, which is estimated from the common driving operation.

6. The support device according to claim 1, further comprising a comparison unit configured to specify a third vehicle smoothly passing through a second place where a predetermined safety measure is implemented before the predetermined safety measure is implemented and a fourth vehicle smoothly passing through the second place after the predetermined safety measure is implemented and compare a traveling history of the third vehicle with a traveling history of the fourth vehicle.

7. A support method executed by a computer, the support method comprising:
specifying a plurality of first vehicles that performs a predetermined driving operation at a first place among vehicles passing through the first place; and
extracting a driving operation common to the first vehicles in a period until the first vehicles reach the first place, from a traveling history of each of the specified first vehicles.

8. A support program causing a computer to execute a process comprising:
specifying a plurality of first vehicles that performs a predetermined driving operation at a first place among vehicles passing through the first place; and
extracting a driving operation common to the first vehicles in a period until the first vehicles reach the first place, from a traveling history of each of the specified first vehicles.
